(19) United States
(12) Patent Application Publication
(10) Pub. No.: US 2006/0117367 A1
(43) Pub. Date: Jun. 1, 2006

(54) Integrated addressing scheme for use in a system having a tree structure

(76) Inventor: James D. Lyle, Santa Clara, CA (US)

Correspondence Address: GIRARD & EQUITZ LLP, 400 MONTGOMERY STREET, SUITE 1110, SAN FRANCISCO, CA, 94104, US

(21) Appl. No.: 10/277,858

(22) Filed: Oct. 22, 2002

(51) Int. Cl. H04N 7/173; H04N 7/16

(52) U.S. Cl. 725/114; 725/144

(57) ABSTRACT

A system including at least one transmitter, at least one repeater (including a router) and optionally at least one receiver, and typically having a tree structure. Commands (each accompanied by an address) and data can be transmitted downstream from each transmitter to each repeater coupled thereto and from each repeater to each device coupled thereto. Preferably, each router is assigned a router access address (that is shared with other routers) and a unique router address. In response to the router access address and a management command, the router performs a management function. Preferably, each repeater has at least one other common address (e.g., a content protection address), and the system implements a protocol in which commands initiate at a root device and travel downstream only, responses travel upstream only, commands broadcast by the root device are seen by each repeater, and responses are point-to-point and are seen only by devices in the direct path between the response-originating device and the root device. Other aspects of the invention are transmitters, repeaters, and receivers, and methods for operating them.

### TECHNICAL FIELD OF THE INVENTION

In preferred embodiments, the invention is a system having a tree structure and configured to distribute data (e.g., video data) to multiple devices, in which each repeater in the system has a unique router address.

### BACKGROUND OF THE INVENTION

There are various, well-known serial links for transmitting video data and other data. One conventional serial link is known as a transition minimized differential signaling interface (“TMDS” link). This link is used primarily for high-speed transmission of video data from a set-top box to a television, and also for high-speed transmission of video data from a host processor (e.g., a personal computer) to a monitor. Among the characteristics of a TMDS link are the following:

1. video data are encoded and then transmitted as encoded words (each 8-bit word of digital video data is converted to an encoded 10-bit word before transmission);

2. the encoded video data and a video clock signal are transmitted as differential signals (the video clock and encoded video data are transmitted as differential signals over conductor pairs without the presence of a ground line);

3. three conductor pairs are employed to transmit the encoded video, and a fourth conductor pair is employed to transmit the video clock signal; and

4. signal transmission occurs in one direction, from a transmitter (typically associated with a desktop or portable computer, or other host) to a receiver (typically an element of a monitor or other display device).

It has been proposed to transmit encrypted video data over a TMDS serial link (e.g., from a set-top box to a television).

Another serial link over which it has been proposed to transmit encrypted video and audio data is the proposed “High Definition Multimedia Interface” interface (“HDMI” link) being developed Silicon Image, Inc., Matsushita Electric, Royal Philips Electronics, Sony Corporation, Thomson Multimedia, Toshiba Corporation, and Hitachi.

It has also been proposed to use the cryptographic protocol known as the “High-bandwidth Digital Content Protection” (“HDCP”) protocol to encrypt digital video data to be transmitted over the “Digital Video Interface” (“DVI” link) adopted by the Digital Display Working Group, and to decrypt the encrypted video data at the DVI receiver. A DVI link can be implemented to include two TMDS links (which share a common conductor pair for transmitting a video clock signal) or one TMDS link, as well as additional control lines between the transmitter and receiver. We shall describe a DVI link (that includes one TMDS link) with reference to FIG. 1. The DVI link of FIG. 1 includes transmitter 1, receiver 3, and the following conductors between the transmitter and receiver: four conductor pairs (Channel 0, Channel 1, and Channel 2 for video data, and Channel C for a video clock signal), Display Data Channel (“DDC”) lines for bidirectional communication between the transmitter and a monitor associated with the receiver in accordance with the conventional Display Data Channel standard (the Video Electronics Standard Association's “Display Data Channel Standard,” Version 2, Rev. 0, dated Apr. 9, 1996), a Hot Plug Detect (HPD) line (on which the monitor transmits a signal that enables a processor associated with the transmitter to identify the monitor's presence), Analog lines (for transmitting analog video to the receiver), and Power lines (for providing DC power to the receiver and a monitor associated with the receiver). The Display Data Channel standard specifies a protocol for bidirectional communication between a transmitter and a monitor associated with a receiver, including transmission by the monitor of Extended Display Identification (“EDID”) data that specifies various characteristics of the monitor, and transmission by the transmitter of control signals for the monitor. Transmitter 1 includes three identical encoder/serializer units (units 2, 4, and 5) and additional circuitry (not shown). Receiver 3 includes three identical recovery/decoder units (units 8, 10, and 12) and inter-channel alignment circuitry 14 connected as shown, and additional circuitry (not shown).

As shown in FIG. 1, circuit 2 encodes the data to be transmitted over Channel 0, and serializes the encoded bits. Similarly, circuit 4 encodes the data to be transmitted over Channel 1 (and serializes the encoded bits), and circuit 6 encodes the data to be transmitted over Channel 2 (and serializes the encoded bits). Each of circuits 2, 4, and 6 responds to a control signal (an active high binary control signal referred to as a “data enable” or “DE” signal) by selectively encoding either digital video words (in response to DE having a high value) or a control or synchronization signal pair (in response to DE having a low value). Each of encoders 2, 4, and 6 receives a different pair of control or synchronization signals: encoder 2 receives horizontal and vertical synchronization signals (HSYNC and VSYNC); encoder 4 receives control bits CTL0 and CTL1; and encoder 6 receives control bits CTL2 and CTL3. Thus, each of encoders 2, 4, and 6 generates in-band words indicative of video data (in response to DE having a high value), encoder 2 generates out-of-band words indicative of the values of HSYNC and VSYNC (in response to DE having a low value), encoder 4 generates out-of-band words indicative of the values of CTL0 and CTL1 (in response to DE having a low value), and encoder 6 generates out-of-band words indicative of the values of CTL2 and CTL3 (in response to DE having a low value). In response to DE having a low value, each of encoders 4 and 6 generates one of four specific out-of-band words indicative of the values 00, 01, 10, or 11, respectively, of control bits CTL0 and CTL1 (or CTL2 and CTL3).

Other serial links include the set of serial links known as Low Voltage Differential Signaling (“LVDS”) links (e.g., “LDI,” the LVDS Display Interface), each of which satisfies the TIA/EIA-644 standard or the IEEE-1596.3 standard, ethernet links, fiberchannel links, serial ATA links used by disk drives, and others.

The invention is applicable to systems comprising devices (e.g., transmitters, receivers, and repeaters) connected by serial links, and is also applicable to systems comprising devices (e.g., transmitters, receivers, and repeaters) connected by parallel links.

The term “channel,” as used herein, refers to a portion of a link that is employed to transmit data (e.g., a particular conductor or conductor pair between the transmitter and receiver over which the data are transmitted, and specific circuitry within the transmitter and/or receiver used for transmitting and/or recovery of the data) and to the technique employed to transmit the data over the link.

In a multi-drop distribution system (e.g., a multi-drop video distribution system), there is a single source (a transmitter) and one or more receivers (e.g., receivers associated with video display devices). All of these devices need unique addresses. The system may also include one or more repeaters, which may need addresses of their own. However, it would be desirable for such a system to be capable of broadcasting some commands from the source to all receivers and repeaters.

In some conventional video distribution systems (e.g., those in which a source transmits video over the video channels of a DVI link), each receiver is associated with a display device that contains an EDID PROM which is accessed on a DDC bus (e.g., the DDC lines of a DVI link as mentioned above). A DDC bus is very similar to an I2C bus. Each EDID PROM in such a system has the same fixed address. Thus, if the system has a tree structure it is impossible to reliably read an individual EDID PROM, or to know which receiver is associated with a display device from which EDID data have been read.

There is a related problem in that a DDC bus is not designed for large, distributed systems. It has electrical limits that both limit its range and increase the difficulty of buffering or extending the range.

In some systems having a tree structure (defined below), each receiver includes an HDCP (or other) content protection subsystem (“block”). Each such block must be addressed individually. HDCP does not solve this problem, except by assuming that each branch will be a separate entity, with some (largely undefined) way of moving data between the branches.

The invention seeks to solve these problems and limitations of the prior art in an integrated way.

### SUMMARY OF THE INVENTION

In a class of embodiments, the invention is a communication system including at least one transmitter and at least one repeater (and typically also at least one receiver), with each transmitter, repeater, and receiver coupled to at least one other transmitter, repeater, and receiver by a link. Data (e.g., video data or audio data) and commands (each accompanied by an address) can be transmitted downstream from each transmitter to each repeater coupled thereto, and from each repeater to each device (repeater or receiver) coupled thereto. Typically, the system has a tree structure and the transmitter is the root node (and is sometimes referred to as the “root device”).

Preferably, each repeater includes a router to which a unique address (to be referred to as a “router address”) is assigned at the time the repeater is manufactured. The router address can be an identification or serial number, and optionally also serves at least one purpose in addition to identifying the router. The router address can be composed of various portions, including some portions that are common to a particular vendor or device family. For example, the router address can include a Vendor ID field, a Product ID field and optionally also a Device Type field, and a sub-code. Only the sub-code need change from one particular router to the next. Alternatively, the router has no unique address (in the sense that neither the router, nor the repeater including the router, remembers a unique address) but is located at a unique location in the system so that it can be “addressed” purely by this unique location. For example, where the system has a tree structure with only one repeater input port per branch, an upstream device (e.g., a transmitter) can assert a command (either accompanied only by a common address, where the expression “common address” denotes an address that is not unique to a device of a system and is instead shared with at least one other device of the system, or accompanied by no address) via a specific link to one repeater, so that this repeater's router is the only router that receives and responds to the command.

Preferably, each repeater is also assigned a common address (to be referred to as a “router access” address) for accessing its router. The router access address is distinct from the above-mentioned router address. In response to the correct router access address and an accompanying management function command, the repeater's router performs a management function. Examples of management functions are identification, status checking, and control functions, and functions that use the router as a conduit to another repeater further downstream. Exemplary functions of the latter type are reading data from a downstream repeater (and forwarding such data to a upstream device that requested the data) and forwarding at least one of data, an address, and a command from an upstream device to one or more downstream repeaters. Typically, a repeater that receives a router access address (from an upstream device over a link) is the only repeater directly connected to the upstream device via the link. In this case, no conflict can arise despite the fact that the router access address is shared by two or more repeaters in the system.

Preferably, each repeater has at least one other common address and each receiver has at least one common address. Examples of such common addresses are an “identification data” address for accessing a memory (in or associated with the repeater or receiver) that contains identification data (e.g., a PROM containing Extended Display Identification (EDID) data or similar identification data, in a monitor associated with the repeater) and a “content protection” address for accessing a selected content protection subsystem (e.g., a cipher engine) of the device.

Preferred embodiments of the inventive system include a repeater configured to execute certain types of commands (e.g., or to read or otherwise process data received with such commands) only if the commands are accompanied by a unique router address for the repeater. For example, when one embodiment of the repeater receives a message, a command to forward the message to a downstream device (e.g., a downstream repeater), and a router access address (shared by the repeater with at least one other repeater) but not the repeater's unique router address, the repeater responds by executing the command without opening, reading, or otherwise processing the message. When this repeater also receives its router address along with the command, message, and router access address, the repeater reads the message (and executes some internal operation in response thereto, where “internal operation” denotes an operation internal to the repeater) and also executes the command by forwarding the message downstream. For another example, when an embodiment of the repeater receives a command to perform an identification, status checking, or control operation, the repeater's router performs the operation specified by the command only if the command is accompanied by the router address.

A repeater of the inventive system is typically configured to execute certain types of commands (and/or process data received with such commands) even if the commands (or commands and data) are not accompanied by a unique address (e.g., a unique address of the repeater's router). For example, it is possible that when a repeater receives a “broadcast” command, a message, and a router access address (shared by the repeater with at least one other repeater) but no unique router address, the repeater responds by executing the command (e.g., by forwarding the command and message to each downstream repeater coupled thereto) and also reading the message and executing an internal operation in response to the message. In a variation on this example, the broadcast command is accompanied only by a message (and is not accompanied by any address) and the repeater responds to the command and message by executing the command (e.g., by forwarding the command and message to each downstream repeater coupled thereto) and also reading the message and executing an internal operation in response to the message.

In a class of embodiments, the inventive system has a tree structure, and includes a transmitter (the root device) configured to assert addresses and commands in accordance with the invention, and at least one repeater and at least one other device to which at least one such address has been assigned. Preferably, each repeater has a router that performs at least the following three functions: gathering information about the repeater itself (such as its address, capabilities, and status); gathering equivalent information about any and all repeaters connected downstream of the repeater (this is preferably done using a switching function of the router that can also be used to isolate branches of the system that do not respond properly or that respond or babble when they should not; and broadcasting commands and/or messages to routers of repeaters that are connected downstream of the repeater and passing the appropriate responses back upstream.

Preferably, the inventive system implements a new transmission protocol. In accordance with the new transmission protocol, commands initiate at the root device and travel only outward (downstream). Responses travel inward (upstream) only, toward the root device. Commands can be broadcast by the root device, and commands that are broadcast are seen by each repeater of a system. Responses are point-to-point, and are seen only by devices in the direct path between the response-originating device and the root device. Commands and responses can but need not share the same communication path. If they do share the same path, each channel that they share along the path will typically not support communication in both directions at the same time so that will be necessary for each router to switch direction between each phase of the transaction, in the sense that a router will only send commands (with accompanying addresses) downstream over the channel during a first phase, and then receive responses over the channel from a downstream device (and forward the response upstream) during the next phase. Alternatively, a command and the response thereto will use completely different paths. For example, in one embodiment, a repeater sends commands downstream on one or more video (or video clock) channels of a TMDS link (e.g., in packets between video frames, or on a modulated clock channel), and the receiver receives the responses on a DDC bus.

A command (with an accompanying address) can define a router (using its pre-set unique address), an address to which the router should forward the command, a command code (e.g., a write code or read code), and any other data that is appropriate. A response to a command will typically contain the result data (if applicable), and an acknowledgment (completion) code.

Preferred embodiments of the invention support split transactions, in the following sense. In the first part of a split transaction, the root device (which can be a repeater, in the case that such repeater is the root device of a branch of a larger system) sends an address, a command, and any related data to a repeater connected thereto, and receives an acknowledgement (e.g., a “retry” acknowledgment) indicating that the operation has begun but is not yet finished. In the second part of a split transaction, the root device receives either an “error” acknowledgment (indicating that the operation is not supported or cannot be completed for some other reason) or a completion acknowledgement. In response to receiving a retry acknowledgement, the root device initiates another transaction to the same device. This transaction either completes, or it too receives a retry acknowledgement.

In preferred embodiments of the inventive system, tree management tasks are performed by repeaters (rather than by the root device) as follows:

each repeater is responsible for gathering data that characterizes the structure of each branch of the device tree that is downstream therefrom. In this way, the entire tree can be determined in a hierarchical way, and the root device (and each repeater) need only query the devices immediately downstream therefrom (using the appropriate known router address and/or router access address);

each repeater includes a router that serves as the router both for itself and for each branch (downstream of the repeater) that does not include its own router or routers. This provides backward compatibility and can reduce the cost of implementing pure “leaf” nodes (where a “leaf” node has no device coupled downstream therefrom). If the structure of a tree reveals that a particular leaf node does not have a router, the router immediately upstream from the leaf node (to be referred to as a “surrogate” router) will assume the router responsibility for that leaf node. A command to read an EDID PROM or HDCP register in (or associated with) the leaf node would go to the surrogate router, and the surrogate router would decode the command, translate it as necessary, and perform the necessary function on the branch that includes the leaf node. The surrogate router preferably does this in isolation from other branches, and using pre-defined function addresses;

each repeater monitors the routers coupled downstream therefrom for “babbling” or otherwise incorrect operation, and disconnects any downstream router that is not behaving properly. It can do this because it knows the structure of the downstream tree, and can see and decode at least some of the commands it receives from an upstream device (e.g., it can typically see and decode each “broadcast” command that it receives from an upstream device). In some cases, a repeater is configured to forward a command only to those downstream routers that are expected to respond to the command, but even when the repeater is configured to forward a command to all downstream routers (including those that are not expected to respond to the command), it preferably is configured to actively disconnect any misbehaving downstream router; and

each repeater monitors the status of downstream branches, and can send “interrupt” (or status change) information upstream toward the root device.

In some embodiments of the invention, commands, addresses, and data are transmitted downstream two or more different channels of a link. In some embodiments, responses to commands are transmitted upstream over a different channel (or different channels) of a link than the channel(s) over which the commands are transmitted downstream.

Other aspects of the invention are transmitters, repeaters, and receivers for use in any embodiment of the inventive system, and methods for operating any embodiment of the inventive transmitter, repeater, or system.

In some embodiments, the inventive repeater is a router configured to forward (but not to translate or otherwise modify) commands, addresses, and/or data to a downstream device, and typically also to perform identification, status checking, and control functions. In other embodiments, the inventive repeater is capable of forwarding translated versions of commands, addresses, and/or data to a downstream device, and its router is typically also capable of performing identification, status checking, and control functions and forwarding (without translating or otherwise modifying) commands, addresses, and/or data to a downstream device. For example, in one of the latter embodiments, the repeater can translate received data in some way (e.g., by decrypting the data, translating the decrypted data, and re-encrypting the translated data) and forward the translated data downstream.

### BRIEF DESCRIPTION OF THE DRAWINGS

FIG. 1 is a block diagram of a conventional system including a Digital Video Interface (“DVI”) link.

FIG. 2 is a block diagram of a system that can be implemented in accordance with the present invention.

### DETAILED DESCRIPTION OF THE PREFERRED EMBODIMENTS

The term “transmitter” is used herein in a broad sense to denote any unit capable of transmitting data over a communication link (and optionally also encoding and/or encrypting the data to be transmitted). The term “receiver” is used herein in a broad sense to denote any unit capable of receiving data that has been transmitted over a communication link (and optionally also decoding and/or decrypting the received data). Unless otherwise specified, the link can, but need not, be a TMDS link or other serial link. For example, the term transmitter can denote a transceiver that performs the functions of a receiver as well as the functions of a transmitter.

Other expressions employed herein include the following:
Downstream: Toward the device (e.g., display device) that is the final destination of transmitted data.
Upstream: Toward the source of a stream (or other quantity) of transmitted data.
Repeater: A device configured to receive content (e.g., encrypted digital data) and forward the content, or to receive content, translate the content (e.g., decrypt and/or otherwise modify or translate the content), and then forward the translated content. One type of repeater (sometimes referred to herein as a “switch”) receives data and forwards the data without decrypting or translating it in any way. A switch buffers the forwarded data to allow for longer links, and can be coupled between at least two upstream devices and at least two downstream devices and configured to selectively forward data from any of the upstream devices to all of the downstream devices or to any selected one (or subset) of the downstream devices (all the downstream links coupled to the selected upstream link will have the same resolution and timing characteristics).
Router: a subsystem of a repeater, configured to perform at least one (and typically more than one) router function, where “router function” denotes forwarding content from an upstream device (e.g., one of multiple upstream devices coupled to the repeater) to a downstream device, forwarding a translated version of content from an upstream device to one or more downstream devices (e.g., to a selected one of multiple downstream devices coupled to the repeater) to a downstream device, or forwarding to an upstream device a downstream device's response to content from the upstream device (or a translated version of such a response). A router is typically also configured to perform at least one other management function, such as but not limited to an identification, status checking, or control function.

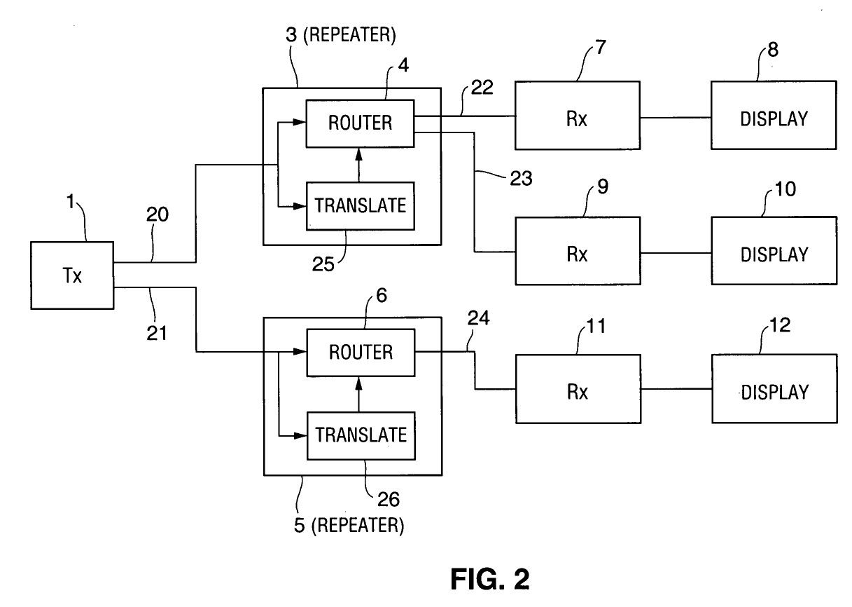

Typically, the invention is implemented in systems that have a tree structure. The expression that a system has a “tree” structure is used herein (including in the claims) to denote that: the system includes a transmitter, at least one repeater, and optionally also at least one receiver; each repeater and receiver is coupled to the transmitter or to at least one other repeater or receiver by a link; each transmitter, repeater, and receiver is a different node of the system; the transmitter is the root node; and the nodes of the system include the root node and additional nodes of at least two different degrees relative to the root node. For example, the FIG. 2 system has a tree structure and includes transmitter 1, repeaters 3 and 5 coupled to transmitter 1 (downstream of the transmitter), receivers 7 and 9 coupled to repeater 3 (downstream of the repeater), and receiver 11 coupled to repeater 5 (downstream of the repeater). In the FIG. 2 system, transmitter 1 is the root node, repeaters 3 and 5 are nodes of a first degree, and receivers 7, 9, and 11 are nodes of a second degree.

In a class of embodiments, the invention is a communication system including at least one transmitter and at least one repeater (and typically also at least one receiver), in which each repeater and receiver is coupled to at least one transmitter and/or to at least one other repeater and/or receiver by a link. Data (e.g., video data or audio data) can be transmitted over each link from each transmitter to at least one repeater, and from each repeater to each device (repeater or receiver) coupled downstream from such repeater.

Each repeater includes a router. Preferably, the router is given a unique address (to be referred to as a “router address”) at the time the repeater is manufactured. The router address can be an identification (ID) or serial number, and optionally also serves at least one purpose in addition to identifying the router. For example, the router address could be used in some cryptographic way (e.g., it could be used as a key selection vector, as in the conventional HDCP protocol).

The unique router address can be composed of various portions, including some portions that are common to a particular vendor or device family. For example, the router address can include a Vendor ID field, a Product ID field and optionally also a Device Type field, and a sub-code. Only the sub-code need change from one particular router to the next. Preferably, the sub-code is kept in some kind of programmable memory (such as EEPROM or FLASH, or a laser-trimmed area) of the repeater. The rest of the router address will not change appreciably from repeater to repeater, and so can be kept in ROM in each repeater.

Each repeater also has a common address (to be referred to as a “router access” address) for accessing its router, where the expression “common address” is used herein (including in the claims) to denote an address that is not unique to a device (of a system) and is instead shared with at least one other device of the system. The router access address is distinct from the above-mentioned unique “router” address. In response to the correct router access address (accompanied by a management function command), the repeater's router performs a management function, such as (but not limited to) an identification, status checking, or control function, or a function that uses the router as a conduit to another repeater further downstream. Exemplary functions of the latter type are reading data from a downstream repeater (and forwarding such data to the upstream device that requested the data) and forwarding data from an upstream device to a downstream repeater. When, as is typical, a repeater that receives a router access address (from an upstream device over a link) is the only repeater directly connected to the upstream device via the link, no conflict can arise despite the fact that the router access address is a common address used by two or more repeaters in the system.

In some embodiments of the inventive system, no router has a unique address (in the sense that no router, nor any repeater including a router, remembers a unique address). Instead, each router is located at a unique location in the system so that it can be “addressed” purely by this unique location. For example, where the system has a tree structure with only one repeater input port per branch (as does the FIG. 2 system), an upstream device (e.g., transmitter 1 of FIG. 2) can assert a command (accompanied only by a common address, or accompanied by no address) via a specific link to one repeater, so that this repeater's router is the only router that receives and responds to the command.

Preferably, each repeater has at least one other common address and each receiver has at least one common address. Typically, each receiver has more than one common address. Examples of such common addresses are an “identification data” address for accessing a memory in the device that contains identification data (e.g., a PROM containing the above-mentioned Extended Display Identification (EDID) data or similar identification data) and a “content protection” address for accessing a selected content protection subsystem of the device (e.g., an HDCP cipher engine or any other element configured to perform an HDCP or non-HDCP content protection function).

In some embodiments, a repeater of the inventive system is configured to execute certain types of commands (e.g., or to read or otherwise process data received with such commands) only if the commands (or commands and data) are accompanied by the repeater's unique router address. For example, when one such repeater receives a message, a command to forward the message to a downstream device (e.g., a downstream repeater), and a router access address (shared by the repeater with at least one other repeater) but does not receive its own router address, the repeater responds by executing the command without opening, reading, or otherwise processing the message. In a variation on this example, if the repeater also receives its router address along with the command, message, and router access address, the repeater would read the message (and execute some internal operation in response thereto) and also execute the command by forwarding the message downstream.

A repeater of the inventive system can be configured to execute certain types of commands (and/or process data received with such commands) even if the commands (or commands and data) are not accompanied by a unique address (e.g., a unique address of the repeater's router). For example, the repeater can be configured so that when it receives a “broadcast” command, a message, and a router access address (which it shares with at least one other repeater) but not its unique router address, the repeater responds by executing the command (by forwarding the command and message to each downstream repeater coupled thereto) and also reading the message and executing an internal operation in response to the message. In a variation on this example, the broadcast command is accompanied only by a message (and is not accompanied by any address) and the repeater responds to the command and message by executing the command (e.g., by forwarding the command and message to each downstream repeater coupled thereto) and also reading the message and executing an internal operation in response to the message.

In some embodiments, a broadcast command has an address field that is ignored by each device that receives and executes the broadcast command. Alternatively, a broadcast command has an address field whose contents are used (by at least one device that receives and executes the broadcast command) for some purpose entirely different than as an address. A broadcast command can include or be accompanied by data (to be forwarded with the command).

In general, a command that is received and executed by at least one device of the inventive system can have more than two associated addresses (e.g., one unique address and one common address), but more typically such a command has only one address associated with it. Each common address is shared by a subset of the devices of the system (e.g., where the devices implement a bit mask scheme), where the subset includes at least two devices.

The communication system of FIG. 2 can be implemented in accordance with the invention. The FIG. 2 system has a tree structure and includes transmitter 1 (the root node), repeater 3 coupled by link 20 to transmitter 1, repeater 5 coupled by link 21 to transmitter 1, receiver 7 coupled by link 22 to repeater 3, receiver 9 coupled by link 23 to repeater 3, and receiver 11 coupled by link 24 to repeater 5. Repeaters 3 and 5 are nodes of a first degree, and receivers 7, 9, and 11 are nodes of a second degree. Repeater 3 includes router 4. Repeater 5 includes router 6. Display device 8 is coupled to receive video data from receiver 7, display device 10 is coupled to receive video data from receiver 9, and display device 12 is coupled to receive video data from receiver 11.

Preferably, transmitter 1 and receivers 7, 9, and 11 implement content protection (and each includes a cipher engine) so that transmitter 1 can transmit encrypted data over links 20 and 21, repeaters 3 and 5 can pass through the encrypted data to one or more of links 22, 23, and 24, and each of receivers 7, 9, and 11 can decrypt the encrypted data received repeater 3 or 5. Preferably, each of display devices 8, 10, and 12 includes an EDID PROM, the EDID PROM of device 8 can be accessed by transmitter 1 (via repeater 3 and receiver 7), the EDID PROM of device 10 can be accessed by transmitter 1 (via repeater 3 and receiver 9), and the EDID PROM of device 12 can be accessed by transmitter 1 via repeater 5 and receiver 11.

Typically, receivers 7, 9, and 11 share the same identification data address. When they do, each receiver is configured to respond to the identification data address (accompanied by an appropriate command) by accessing the EDID PROM of the display device coupled thereto.

Typically, receivers 7, 9, and 11 share the same content protection address. When they do, the content protection subsystem of each receiver is configured to respond to the content protection address (accompanied by an appropriate command) by performing a content protection operation, when the appropriate one of repeaters 3 and 5 forwards such address and command to the receiver from the content protection subsystem of transmitter 1.

In accordance with the invention, each of routers 4 and 6 has a unique router address, and repeaters 3 and 5 also share a router access address. These addresses can be used as described above. For example, transmitter 1 can send to repeater 5 (over link 21) a message, a command to forward the message to a downstream device, and the router access address (but not the unique router address of repeater 5). In this example, router 6 of repeater 5 is configured to respond to these three items by executing the command (forwarding the message to receiver 11) without opening, reading, or otherwise processing the message. In a variation on the previous example, transmitter 1 sends (to repeater 5) repeater 5's unique router address along with the same command, message, and router access address that transmitter 1 sends in the previous example. In this variation, router 6 of repeater 5 is configured to respond to these four items by reading the message (and executing some internal operation in response thereto) as well as executing the command (forwarding the message to receiver 11).

For another example, repeater 3 can receive a command to forward encrypted data (from transmitter 1) to a specific one of receivers 7 and 9 determined by the command, and a router access address. In response to the command and router access address, repeater 3 forwards the data to the appropriate one of receivers 7 and 9.

In some implementations of FIG. 2, repeaters 3 and 5 implement a content protection function and each includes a cipher engine (e.g., in translation subsystem 25 of repeater 3 or translation subsystem 26 of repeater 5). In some such implementations, repeater 3 responds to a content protection address (accompanied by an appropriate command) by performing a content protection operation (e.g., encrypting or decrypting data received from transmitter 1 in translation subsystem 25 and asserting the encrypted or decrypted data to router 4) and optionally also forwarding to one or both of receivers 7 and 9 (from router 4) an encrypted or decrypted version of data received from transmitter 1. The command could specify which of receivers 7 and 9 should receive the encrypted or decrypted data.

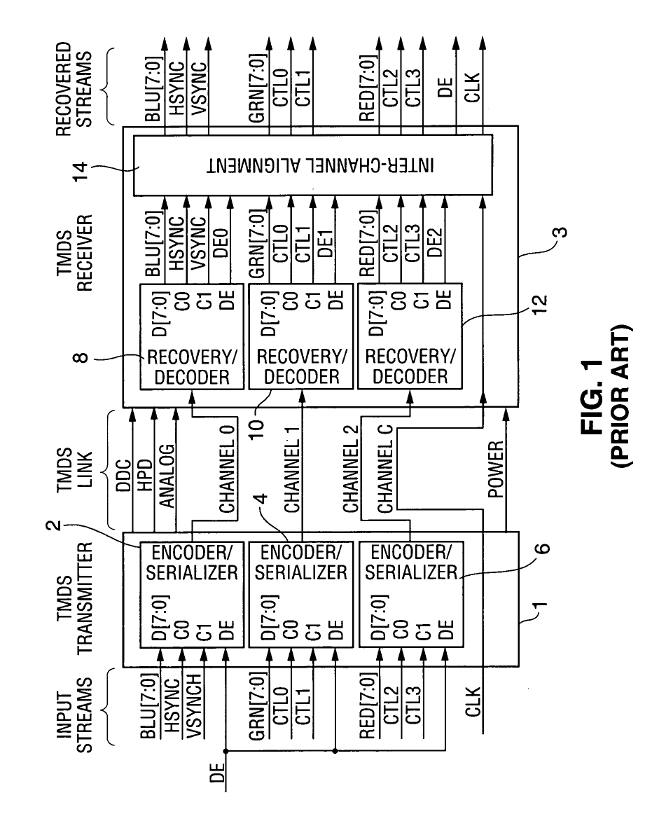

A repeater (e.g., a repeater that is a switch, as defined above) that does not have an EDID PROM and does not implement a content protection function would not need an identification data address or content protection address, and would not be configured to respond to an EDID or content protection address. For example, a variation of repeater 3 of FIG. 1 which lacks subsystem 25 (and lacks an EDID PROM), and consists of router 4 only, is a repeater that is a switch. However, identification data addresses and content protection addresses could be allocated even to a repeater that is purely a switch (such addresses would be shared by such a repeater with at least one other device). For example, a variation on repeater 3 or 5 of FIG. 2 that consists of a router only (e.g., router 4 or 6) can be allocated an identification data address and a content protection address even though such repeater does not implement a content protection function (or include a cipher engine) and does not include an EDID PROM. In this case, if such variation on repeater 3 or 5 were replaced by a device that does implement a content protection function and/or include an EDID PROM, transmitter 1 would be able to communicate with the replacement device using the predetermined identification data address and/or content protection address.

In some embodiments of the invention, a repeater implements a content protection function, and includes a cipher engine, registers for storing values used by the cipher engine to implement the content protection function, and a router. In some cases, the router shares at least some of such registers with the cipher engine.

In embodiments of the invention in which a repeater implements a content protection function, and receives a content protection address (from an upstream device) over a link, the receiver is typically the only repeater directly connected to the upstream device via the link (i.e., the link is typically a point-to-point link). Thus, in the typical case, no conflict can arise despite the fact that the content protection address is a common address used by two or more repeaters in the system. In response to a content protection command accompanied by the content protection address, the repeater would execute the command.

Addresses can be allocated to the devices of a system in accordance with the invention even when the system includes no repeater and does not have a tree structure. For example, one such system consists of a transmitter (configured to assert addresses and commands in accordance with the invention) and at least one other device (to which at least one such address has been assigned). In a system in which addresses have been assigned in accordance with the invention but which does not have a tree structure, communication between the transmitter and each downstream device preferably occurs exactly as if only conventional addresses had been assigned to each downstream device. This provides backwards compatibility. For example, the transmitter is preferably configured to access an EDID PROM and/or content protection circuit in (or associated with) each downstream device using conventional addresses and conventional predefined interfaces.

In a class of embodiments, the inventive system has a tree structure, and includes a transmitter (the root device) configured to assert addresses and commands in accordance with the invention, and at least one repeater and at least one other device to which at least one such address has been assigned. Preferably, each repeater has a router that performs at least the following three functions:

gathering information about the repeater itself (such as its address, capabilities, and status);

gathering equivalent information about any and all repeaters connected downstream of the repeater. This is preferably done using a switching function of the router that can also be used to isolate branches of the system that do not respond properly (or that respond or babble when they should not); and

broadcasting commands and/or messages to routers of repeaters that are connected downstream of the repeater, and passing the appropriate responses back upstream.

Preferably, the inventive system implements a new transmission protocol. In accordance with the new transmission protocol, commands initiate at the root device and travel only outward (downstream). Responses travel inward (upstream) only, toward the root device. Commands can be broadcast by the root device, and commands that are broadcast are seen by each repeater of a system. Responses are point-to-point, and are seen only by devices in the direct path between the response-originating device and the root device. This new transmission protocol differs from but is compatible with the protocol conventionally used on DDC (I2C) lines.

In accordance with the new transmission protocol, commands and responses can but need not share the same communication path. If they do share the same path, each channel that they share along the path will typically not support communication in both directions at the same time so that will be necessary for each router to switch direction between each phase of the transaction, in the sense that a router will only send commands (with accompanying addresses) downstream over the channel during a first phase, and then receive responses over the channel from a downstream device (and forward the response upstream) during the next phase. A router can easily be implemented to function in this manner because there will be a single boundary between the transaction phases and this boundary will be distinct and readily identifiable.

Alternatively, a command and the response thereto will use completely different paths. For example, in one embodiment, a repeater sends commands downstream on one or more video (or video clock) channels of a TMDS link (e.g., in packets between video frames, or on a modulated clock channel), and the receiver receives the responses on a DDC bus.

A command (with an accompanying address) can define a router (using its pre-set unique address), an address to which the router should forward the command, a command code (e.g., a write code or read code), and any other data that is appropriate. The response will typically contain the result data (if applicable), and an acknowledgment (completion) code.

There may be some latency involved in certain operations (e.g., in execution of some commands). It is typically undesirable to wait for long-latency operations to complete. Therefore, preferred embodiments of the invention support “split” transactions in the following sense. In the first part of a split transaction, the root device sends an address, a command, and any related data to a repeater, and receives an acknowledgement (e.g., a “retry” acknowledgment) indicating that the operation has begun but is not yet finished. In the second part of a split transaction, the root device receives either an “error” acknowledgment (indicating that the operation is not supported or cannot be completed for some other reason) or a completion acknowledgement. In this context, the root device can be a repeater, namely a repeater that is the root device of a branch of a larger system.

In response to receiving a retry acknowledgement, the root device initiates another transaction to the same device. This transaction either completes, or it too receives a retry acknowledgement.

In preferred embodiments, tree management tasks are off-loaded (from the root device) to repeater devices as follows:

(1) each repeater is responsible for gathering data that characterizes the structure of each branch of the device tree that is downstream therefrom. In this way, the entire tree can be determined in a hierarchical way, and the root device (and each repeater) need only query the devices immediately downstream therefrom (using the appropriate known router address and/or router access address);

(2) each repeater includes a router that serves as the router both for itself and for each branch (downstream of the repeater) that does not include its own router or routers. This provides backward compatibility and can reduce the cost of implementing pure “leaf” nodes (where a “leaf” node has no device coupled downstream therefrom). If the structure of a tree reveals that a particular leaf node does not have a router, the router immediately upstream from the leaf node (to be referred to as a “surrogate” router) will assume the router responsibility for that leaf node. A command to read an EDID PROM or HDCP register in (or associated with) the leaf node would go to the surrogate router, and the surrogate router would decode the command, translate it as necessary, and perform the necessary function on the branch that includes the leaf node. The surrogate router preferably does this in isolation from other branches, and using pre-defined function addresses;

(3) each repeater monitors the routers coupled downstream therefrom for “babbling” or otherwise incorrect operation, and disconnects any downstream router that is not behaving properly. It can do this because it knows the structure of the downstream tree, and can see and decode at least some of the commands it receives from an upstream device (e.g., it can typically see and decode each “broadcast” command that it receives from an upstream device). In some cases, a repeater is configured to forward a command only to those downstream routers that are expected to respond to the command, but even when the repeater is configured to forward a command to all downstream routers (including those that are not expected to respond to the command), it preferably is configured to actively disconnect any misbehaving downstream router; and

(4) each repeater monitors the status of downstream branches, and can send “interrupt” (or status change) information upstream toward the root device.

A router of the type described herein is preferably implemented in each of the repeaters of a system that embodies the invention, except that a router is optionally implemented (and not required) in a repeater that is connected as a “leaf” node (a node with no device coupled downstream of it). A repeater connected as a leaf node can include a router (that implements a full or partial set of router functions) if the leaf node requires at least one router capability other than a switching capability (e.g., an expanded diagnostic or control capability, or an additional downstream bandwidth or buffering capability) or if a content protection mechanism (or other function) in the leaf node requires a router interface for its own use.

In systems that embody the invention, tree management preferably occurs as follows:

(1) the root device detects when a new device is coupled to the system;

(2) if the new device is a repeater, it will have a router. The root device queries this router for information about any and all “trees” (branches of the overall system) downstream of the new device. The root device builds this information into a cohesive map of the entire system. This “map updating” operation may take significant time, but the structure of the inventive system allows many operations to proceed in parallel with a map updating operation. A map updating operation can be accomplished without using the command/response capabilities of preferred embodiments of the inventive system, though these capabilities can optionally be used if repeaters are present;

(3) once the updated map is built, the root device preferably uses it to individually address each device in the system using the command/response capabilities of preferred embodiments of the invention. Leaf nodes that do not have routers are preferably addressed through their “surrogate” router(s) as explained above; and

(4) the root device occasionally queries the closest router(s) for status change information (each router preferably gathers such status change information from all downstream routers on a continuous basis). When a status change is detected, the root device can query each appropriate individual router for more detailed information.

The router of an embodiment of the inventive repeater (e.g., router 4 of repeater 3 of FIG. 2) can function as a switch having at least two inputs (each of which can be coupled to an upstream device via a link) and at least two outputs (each of which can be coupled to a downstream device via a link. The switch can be a cross-point switch that allows any of its inputs to be connected to any of its outputs. In variations on such an implementation, the router functions as two or more switches that are “ganged” subject to the following rules:
no two input ports may be connected together;
any output port may be connected to at most one input port at a time;
an input port may be connected to more than one output port;
an output port need not be connected to any input port; and
whenever a TMDS link (or other multi-channel link) at an input port is connected to a TMDS link (or other multi-channel link) at an output port, the corresponding communication channels must always be connected together.

In another class of embodiments, the invention is a method for designing a tree-structured communication system that is to include a transmitter configured to assert addresses and commands, at least one primary repeater having a primary router and being configured to be coupled to the transmitter downstream from said transmitter, and at least two secondary repeaters, each having a secondary router and being configured to be coupled to the primary repeater downstream from said primary repeater. The method includes the steps of assigning a router access address to each of the secondary routers, such that all of the secondary routers share said router access address; and assigning a unique router address to each said primary router and each of the secondary routers, such that no two of the primary and secondary routers share one said router address.

Optionally, the method also includes one or both of the steps of: assigning the router access address to each said primary router, such that all of the primary and secondary routers share said router access address; and assigning at least one additional address to each of the secondary repeaters, such that all of the secondary routers share each said additional address. The at least one additional address can include one or both of an identification data address (for use in triggering an access to a memory that contains identification data) and a content protection address.

It should be understood that while certain forms of the present invention are illustrated and described herein, the invention is defined by the claims and is not to be limited to the specific embodiments described and shown. For example, although some of the specific embodiments are described herein as being a method or system for transmitting video data, variations on these embodiments are contemplated in which audio data (or other data) rather than video data are transmitted.

What is claimed is:

1. A communication system, comprising:
at least two devices, including a transmitter and at least one repeater; and
a link which couples the transmitter to the repeater, wherein the repeater includes a router having a router access address and a unique router address, and the repeater is configured to perform a management function in response to a management function command and the router access address, and to perform at least one other function in response to a second command but only if the second command is accompanied by the router address.

2. The system of claim 1, also including a second repeater and a second link which couples the transmitter to the second repeater, and wherein the router access address is shared by the repeater and the second repeater.

3. The system of claim 1, wherein the repeater is configured to respond to assertion of the router address of its router in at least one manner other than by performing said other function in response to the second command accompanied by said router address.

4. The system of claim 1, wherein the management function is one of an identification, status checking, and control function.

5. The system of claim 1, wherein the transmitter and the repeater are configured to implement a split transaction comprising a first part and a second part, wherein during the first part the transmitter sends at least an address and a command to the repeater and receives a first acknowledgement indicating that an operation in response to the address and the command has begun but is not yet finished, and wherein during the second part the transmitter receives one of an error acknowledgment and a completion acknowledgement from the repeater.

6. The system of claim 1, also including a second repeater and a second link which couples the repeater to the second repeater, and wherein the management function is an operation in which the router obtains data from the second repeater and forwards the data to the transmitter.

7. The system of claim 1, also including a second repeater and a second link which couples the repeater to the second repeater, and wherein the management function is an operation in which the router forwards at least one of data, an address, and a command to the second repeater.

8. The system of claim 1, wherein the repeater has at least one additional address that is not unique to said repeater.

9. The system of claim 8, wherein the at least one additional address includes an identification data address, and the transmitter is configured to assert the identification data address to trigger an access to a memory that contains identification data.

10. The system of claim 8, wherein the at least one additional address includes a content protection address.

11. The system of claim 10, wherein the repeater has a content protection subsystem, and the transmitter is configured to assert the content protection address to the repeater to trigger an access to the content protection subsystem.

12. The system of claim 1, also including a receiver and a second link which couples the repeater to the receiver, and wherein the receiver has at least one address that is not unique to said receiver.

13. The system of claim 12, wherein the receiver has an identification data address that is not unique to said receiver, the system also includes a memory that contains identification data, the memory is in or associated with the receiver, and the transmitter is configured to assert the identification data address to trigger an access to said memory.

14. The system of claim 12, wherein the receiver has a content protection address that is not unique to said receiver.

15. The system of claim 1, wherein the second command is a command for the router to perform at least one of an identification, status checking, and control operation.

16. The system of claim 15, also including a device and a second link which couples the repeater to the device, and wherein the management function command is a command for the router to forward data to the device, and said router is configured to execute the management function command in response to receipt by the repeater of said management function command accompanied by the data and said router access address.

17. The system of claim 1, also including a device and a second link which couples the repeater to the device, and wherein the management function command is a command for the router to forward data to the device, and said router is configured to execute the management function command in response to receipt by the repeater of said management function command accompanied by the data and the router access address.

18. The system of claim 17, wherein the second command is said management function command, and the router is configured to execute said management function command and to perform at least one internal operation in response to the data, in response to receipt by the repeater of said management function command accompanied by said data, the router access address, and the router address.

19. The system of claim 1, also including a device and a second link which couples the repeater to the device, and wherein the second command is a command to forward data to the device, and the router is configured to execute the second command, and perform at least one internal operation in response to the data, in response to receipt by the repeater of said second command accompanied by said data, the router access address, and the router address.

20. The system of claim 1, also including a second repeater, a second link which couples the repeater to the second repeater, a third repeater, and a third link which couples the repeater to the third repeater, wherein the management function command is a broadcast command, and the router is configured to execute the broadcast command by forwarding the broadcast command to the second repeater and the third repeater and to perform at least one internal operation in response to the broadcast command, in response to receipt by the repeater of said broadcast command accompanied by the router access address.

21. The system of claim 1, wherein the system has a tree structure including a root node and additional nodes of at least two different degrees relative to the root node, the transmitter is the root node, and the repeater is a primary repeater, and also including:
at least one other device coupled to the primary repeater downstream from said primary repeater, wherein each of the primary repeater and said at least one other device is one of the additional nodes.

22. The system of claim 21, wherein said at least one other device is a receiver that is not a repeater.

23. The system of claim 21, wherein the management function is one of an identification, status checking, and control function.

24. The system of claim 21, wherein the primary repeater includes a first router, and the management function is an operation in which the first router obtains data from a repeater connected downstream of said first router and forwards the data to the transmitter.

25. The system of claim 21, wherein the primary repeater includes a first router, and the management function is an operation in which the first router forwards at least one of data, an address, and a command to a repeater connected downstream from said first router.

26. The system of claim 21, wherein the primary repeater includes a first router, and the second command is a command for the first router to perform at least one of an identification, status checking, and control operation.

27. The system of claim 26, wherein the management function command is a command for the first router to forward data to a downstream device, and the first router is configured to execute the management function command in response to receipt by the primary repeater of said management function command accompanied by the data and the first router's router access address.

28. The system of claim 21, wherein the primary repeater includes a first router, the management function command is a command for the first router to forward data to a downstream device, and the first router is configured to execute the management function command in response to receipt by the primary repeater of said management function command accompanied by the data and the first router's router access address.

29. The system of claim 28, wherein the second command is said management function command, and the first router is configured to execute said management function command and to perform at least one internal operation in response to the data, in response to receipt by the primary repeater of said management function command accompanied by said data, the first router's router access address, and the first router's router address.

30. The system of claim 21, wherein the primary repeater includes a first router, the second command is a command to forward data to a downstream device, and the first router is configured to execute the second command and perform at least one internal operation in response to the data, in response to receipt by the primary repeater of said second command accompanied by said data, the first router's router access address, and the first router's router address.

31. The system of claim 21, wherein the primary repeater includes a first router, the management function command is a broadcast command, and the first router is configured to execute the broadcast command by forwarding the broadcast command to each repeater coupled downstream from the first router and to perform at least one internal operation in response to the broadcast command, in response to receipt by the primary repeater of said broadcast command accompanied by the first router's router access address.

32. The system of claim 21, wherein the primary repeater, and at least one said device coupled to the primary repeater downstream from said primary repeater, are configured to implement a split transaction comprising a first part and a second part, wherein during the first part the primary repeater sends at least an address and a command to the device and receives a first acknowledgement indicating that an operation in response to the address and the command has begun but is not yet finished, and wherein during the second part the primary repeater receives one of an error acknowledgment and a completion acknowledgement from the device.

33. The system of claim 21, wherein each of the primary repeater and each said other device that is a repeater is configured to gather data that characterizes the structure of each branch of the system that is downstream therefrom.

34. The system of claim 21, wherein each said other device that is a repeater includes a router configured to perform a router function both for said repeater itself, and for each branch of the system downstream of said repeater that does not include its own router.

35. The system of claim 1, also including at least one downstream repeater coupled to the repeater, and wherein the repeater is configured to monitor each said downstream router for incorrect operation, and to decouple each said downstream router that performs an incorrect operation.

36. The system of claim 1, wherein the repeater is configured to monitor the status of each branch of the system that is downstream of said repeater and to send an indication of a change of status of each said branch upstream to the transmitter.

37. A communication system having a tree structure, including a root node and additional nodes of at least two different degrees relative to the root node, said system including:
a transmitter configured to assert commands; and
at least one primary repeater, having a first router, and coupled to the transmitter downstream from said transmitter; and
at least two secondary repeaters, each having a secondary router and each coupled to the primary repeater downstream from said primary repeater, wherein the transmitter is the root node and each of the primary repeater and the secondary repeaters is one of the additional nodes, and
wherein the first router is configured to broadcast at least one of the commands to the secondary repeaters and to pass responses from the secondary repeaters upstream to the transmitter.

38. The system of claim 37, wherein the transmitter is configured to assert addresses with each of at least some of the commands, at least two of the addresses have been assigned to the first router, and at least two of the addresses have been assigned to each said secondary router.

39. The system of claim 38, wherein the first router has a router address and a router access address, and the router address but not the router access address is unique to the first router.

40. The system of claim 37, wherein the first router is configured to gather information about the primary repeater and to gather information about the secondary routers from the secondary routers.

41. The system of claim 37, wherein the first router has a switching function that isolates selected branches of the system from said first router, and the first router is configured to use the switching function to gather information about the secondary routers.

42. The system of claim 37, wherein the primary repeater and the secondary repeaters are configured to implement a split transaction comprising a first part and a second part, wherein during the first part the primary repeater sends at least an address and a command to at least one of the secondary repeaters and receives a first acknowledgement indicating that an operation in response to the address and the command has begun but is not yet finished, and wherein during the second part the primary repeater receives one of an error acknowledgment and a completion acknowledgement from at least one of the secondary repeaters.

43. The system of claim 37, wherein the transmitter and the primary repeater are configured to implement a split transaction comprising a first part and a second part, wherein during the first part the transmitter sends at least an address and a command to the primary repeater and receives a first acknowledgement indicating that an operation in response to the address and the command has begun but is not yet finished, and wherein during the second part the transmitter receives one of an error acknowledgment and a completion acknowledgement from the primary repeater.

44. The system of claim 37, wherein each of the primary repeater and the secondary repeaters is configured to gather data that characterizes the structure of each branch of the system that is downstream therefrom.

45. The system of claim 37, wherein each said first router and secondary router is configured to perform a router function both for a repeater that contains it, and for each branch of the system downstream of said repeater that does not include its own router.

46. The system of claim 37, wherein the primary repeater is configured to monitor each of the secondary repeaters for incorrect operation and to decouple each of the secondary repeaters that performs an incorrect operation.

47. The system of claim 37, wherein the primary repeater is configured to monitor the status of each branch of the system that is downstream therefrom and to send an indication of a change of status of each said branch upstream to the transmitter.

48. A communication system having a tree structure, including a root node and additional nodes of at least two different degrees relative to the root node, said system including:
a transmitter configured to assert commands; and
at least two primary repeaters, each having a first router and each coupled to the transmitter downstream from said transmitter; and
at least two secondary repeaters, each having a secondary router and each coupled to one of the primary repeaters downstream from said one of the primary repeaters, wherein the transmitter is the root node and each of the primary repeaters and the secondary repeaters is one of the additional nodes, and
wherein the transmitter is configured to broadcast at least one of the commands to the primary repeaters, each of the primary repeaters is configured to respond to said one of the commands by forwarding said one of the commands to each of the secondary repeaters coupled thereto and performing at least one internal operation in response to said one of the commands, and each of the primary repeaters is configured to pass responses, from the secondary repeaters coupled thereto, upstream to the transmitter.

49. The system of claim 48, wherein the transmitter is configured to assert addresses with each of at least some of the commands, at least two of the addresses have been assigned to each said first router, and at least two of the addresses have been assigned to each said secondary router.

50. A repeater for use in a communication system, said repeater including:
at least one input configured to be coupled to an upstream link;
at least one output configured to be coupled to a downstream link; and
a router coupled to each said input and each said output, wherein the router has
a router access address and a unique router address, the router is configured to perform a management function in response to a management function command and the router access address, and the router is configured to perform at least one other function in response to a second command but only if the second command is accompanied by the router address.

51. The repeater of claim 50, wherein the management function is one of an identification, status checking, and control function.

52. The repeater of claim 50, wherein the management function is an operation in which the router obtains data from a device connected via a downstream link to one said output and forwards the data to another device connected an upstream link to one said input.

53. The repeater of claim 50, wherein the management function is an operation in which the router forwards at least one of data, an address, and a command to a device connected via a downstream link to one said output.

54. The repeater of claim 50, wherein said repeater has at least one additional address that is not unique to said repeater.

55. The repeater of claim 54, wherein the at least one additional address includes an identification data address.

56. The repeater of claim 54, wherein the at least one additional address includes a content protection address.

57. The repeater of claim 50, wherein the at least one other function performed in response to the second command accompanied by the router address is at least one of an identification, status checking, and control operation.

58. The repeater of claim 50, wherein the management function is an operation in which the router forwards data to a device connected via a downstream link to one said output, and the router is configured to perform the management function in response to said management function command accompanied by the data and the router access address.

59. The repeater of claim 50, wherein the management function command is a broadcast command, and the router is configured to execute the broadcast command by forwarding data to each repeater that is connected via a downstream link to one said output and to perform at least one internal operation, in response to said broadcast command accompanied by said data and the router access address.

60. The repeater of claim 50, wherein said repeater is configured to gather data that characterizes the structure of each branch of the system that is coupled via a downstream link to one said output.

61. The repeater of claim 50, wherein the router is configured to perform a router function both for the repeater itself, and for each branch of the system that is coupled via a downstream link to one said output and does not include its own router.

62. The repeater of claim 50, wherein the repeater is configured to monitor each downstream'router that is coupled via a downstream link to one said output for incorrect operation, and to disconnect each said downstream router that performs an incorrect operation.

63. The repeater of claim 50, wherein the repeater is configured to monitor the status of each branch of the system that is coupled via a downstream link to one said output, and to send an indication of a change of status of each said branch to a transmitter coupled via an upstream link to one said input.

64. A repeater for use in a communication system having a tree structure having a root node that is a transmitter and additional nodes of at least two different degrees relative to the root node, said repeater including:
at least one input configured to be coupled via an upstream link to the transmitter;
at least two outputs, each configured to be coupled to a different one of the additional nodes via a different one of a set of downstream links; and
a router coupled to each said input and each of the outputs, wherein the router is configured to respond to at least one command by broadcasting the command to other repeaters coupled via the downstream links to the outputs and passing responses from the other repeaters to one said input.

65. The repeater of claim 64, wherein the router has a router access address and a router address, the router address but not the router access address is unique to said router, and the router is configured to respond to the command only if said command is accompanied by the router access address, by broadcasting the command to other repeaters coupled via the downstream links to the outputs and passing responses from the other repeaters to one said input.

66. The repeater of claim 64, wherein the router is configured to gather information about said repeater and about other devices coupled via the downstream links to the outputs.

67. The repeater of claim 64, wherein the router has a switching function that isolates selected branches of the system from said router, and the router is configured to use the switching function gather information about devices coupled via the downstream links to the outputs.

68. The repeater of claim 64, wherein said repeater is configured to gather data that characterizes the structure of each branch of the system that is coupled via a downstream link to one of the outputs.

69. The repeater of claim 64, wherein the router is configured to perform a router function both for the repeater itself, and for each branch of the system that is coupled via a downstream link to one of the outputs and does not include its own router.

70. The repeater of claim 64, wherein the repeater is configured to monitor each downstream router, that is coupled via a downstream link to one of the outputs, for incorrect operation, and to disconnect each said downstream router that performs an incorrect operation.

71. The repeater of claim 64, wherein the repeater is configured to monitor the status of each branch of the system that is coupled via a downstream link to one of the outputs, and to send an indication of a change of status of each said branch to one said input.

72. A transmitter for use in a communication system, said transmitter including:
at least two outputs, each configured to be coupled to a different link; and
circuitry, coupled and configured to assert a management function command and an accompanying router access address to each of the outputs for transmission over each link that is coupled to one of the outputs, wherein the circuitry is also configured to assert a second command and an accompanying router address to each of the outputs for transmission over each link that is coupled to one of the outputs.

73. The transmitter of claim 72, wherein the management function command is a command to perform one of an identification, status checking, and control function.

74. The transmitter of claim 72, wherein the management function command is a command for causing a router to obtain data from a downstream device and to forward the data to said transmitter.

75. The transmitter of claim 72, wherein the management function command is a command for causing a router to forward at least one of data, an address, and a command to a downstream device.

76. The transmitter of claim 72, wherein the second command is a command for a router to perform at least one of an identification, status checking, and control operation.

77. The transmitter of claim 72, wherein the circuitry is configured to assert data with the management function command to each of the outputs, and wherein the management function command is a broadcast command for causing a router to forward the data to each repeater coupled to said router and causing the router to perform at least one internal operation.

78. A transmitter for use in a communication system having a tree structure having a root node that is said transmitter and additional nodes of at least two different degrees relative to the root node, said transmitter including:
at least two outputs, each configured to be coupled to a different link; and
circuitry, coupled and configured to assert a broadcast command to each of the outputs for transmission over each link that is coupled to one of the outputs, wherein the broadcast command is a command for causing a router to forward said broadcast command to each repeater coupled to said router and causing the router to perform at least one internal operation.

79. A method for designing a tree-structured communication system that is to include a transmitter configured to assert addresses and commands, at least one primary repeater having a primary router and configured to be coupled to the transmitter downstream from said transmitter, and at least two secondary repeaters, each having a secondary router and configured to be coupled to the primary repeater downstream from said primary repeater, said method including the steps of:
assigning a router access address to each of the secondary routers, such that all of the secondary routers share the router access address; and
assigning a unique router address to each said primary router and each of the secondary routers, such that no two of the primary and secondary routers share one said router address.

80. The method of claim 79, also including the step of assigning the router access address to each said primary router, such that all of the primary and secondary routers share said router access address.

81. The method of claim 79, also including the step of assigning at least one additional address to each of the secondary repeaters, such that all of the secondary routers share each said additional address.

82. The method of claim 81, wherein the at least one additional address includes an identification data address for use in triggering an access to a memory that contains identification data.

83. The method of claim 81, wherein the at least one additional address includes a content protection address.
